(19) United States
(12) Patent Application Publication
(10) Pub. No.: US 2001/0002511 A1
(43) Pub. Date: Jun. 7, 2001

(54) ELECTRICAL CONTACT SYSTEM, ELECTRICAL CONTACT FORMING MEMBER, AND METHOD OF FORMING AN ELECTRICAL CONTACT ON A WORKPIECE

(76) Inventor: MITCHELL ZALESKI, NORTHBROOK, IL (US)

Correspondence Address: PENNIE & EDMONDS LLP, 1667 K STREET NW, SUITE 1000, WASHINGTON, DC, 20006

(21) Appl. No.: 09/237,892

(22) Filed: Jan. 27, 1999

Related U.S. Application Data
(63) Continuation-in-part of application No. 08/896,327, filed on Jul. 17, 1997, now abandoned.

(51) Int. Cl. B23P 19/00

(52) U.S. Cl. 29/882; 29/795; 29/876

(57) ABSTRACT

The present invention is directed toward an elongated member, such as a tape, which can be severed into multiple contact inserts for use in place of conventional rivet-type contacts. The elongated member includes an elongated head and an elongated body which form a contact head and a contact body when the member is severed without a cold heading operation. The members are designed such that the body of the contact insert is deformed when the contact is secured to a workpiece, such as a metal stamping. The members can be fed directly into a progressive die used to make the stamping, and severed into contact inserts and secured to the stamping within the die.

### CROSS-REFERENCE TO RELATED APPLICATIONS

This is a continuation-in-part of application No. 08/896,327, filed Jul. 17, 1997.

### FIELD OF THE INVENTION

The present invention relates generally to an elongated member or tape for producing an electrical contact and an electrical contact delivery system, to an electrical contact on a workpiece where the electrical contact is formed from a severed portion of an elongated member, and to a method for making and attaching an electrical contact to a workpiece.

### BACKGROUND OF THE INVENTION

Electrical contacts have been used as components in electrical switches in a wide variety of devices. The contacts are electrically conductive and provide a contact which may be brought in and out of contact with another switch component to open and close the switch. The electrical contact is typically attached to another piece of electrically conductive metal, such as a metal workpiece or stamping made by a punch press machine. Workpieces are sometimes blade-shaped, or elongated in length, and often have a narrow profile.

One existing method of attaching an electrical contact to a workpiece is by welding a contact to a workpiece. The strength of the bond and the electrical conductivity between the welded parts is dependent upon the integrity of the weld joint and is affected by the extent that the two parts are fused together during the welding process. The welding operation is typically performed in a welding machine, which is independent from the punch press used to make the metal workpiece or stamping. In this method, contact welding tape, a continuously clad metal product, may be joined to a contact arm assembly by means of resistance welding or brazing. After assembly, the weld joint between the contact welding tape and the workpiece is usually tested by utilizing a push test.

Another method of attaching an electrical contact to a workpiece or stamping is by riveting a rivet-type contact to the workpiece, as discussed in U.S. Pat. No. 5,218,756 to Zaleski, the disclosure of which is incorporated herein by reference in its entirety. Rivet-type contacts typically have an enlarged circular head and a cylindrical shaft connected to the head. The shaft of the rivet-type contact is inserted into a hole defined in the workpiece and staked or upset to retain the contact in the workpiece.

Rivet-type contacts are typically manufactured by cold heading specialists, who utilize machines which take ordinary round wire and cut off and upset, or cold head, the head of the contact. Typical manufacturers who utilize electrical contacts in connection with work pieces do not have the expertise or equipment necessary to make rivet-type inserts. Consequently, rivet-type inserts are normally a purchased component for electrical contact manufacturers. Furthermore, after rivet-type electrical contacts are assembled, they are typically subjected to rotation tests to confirm the integrity of the association between the rivet-type electrical contact and the workpiece.

### SUMMARY OF THE INVENTION

The present invention is directed toward a method of providing an electrical contact on a workpiece, to a system for providing an electrical contact on a workpiece, to an electrical contact system, and to an electrical contact forming member.

The method of providing an electrical contact on a workpiece of the present invention preferably includes providing a workpiece with a contact opening, aligning an elongated member with the contact opening of the workpiece, severing a portion from the elongated member to define a contact insert, and transferring the contact insert to the contact opening of the workpiece for securement thereto to provide an electrical contact on the workpiece.

Preferably, at least part of the contact insert is deformable and is secured to the workpiece by deformation against the workpiece. The method may include exerting a force to cause the severing and transferring steps to occur in concert. The method may also include configuring the elongated member as a metal tape having a head portion, a body portion associated with the head portion, and at least one shoulder defined between the head portion and the body portion so that the contact insert includes the head portion, body portion, and shoulder portion after the elongated member is severed. The body portion may be a deformable material to facilitate securing the contact insert to the workpiece. Also, the transferring step may include inserting only the body portion of the contact insert into the contact opening defined in the workpiece.

The positioning step may include abutting the head portion of the contact insert against the workpiece to position the contact insert in the contact opening. The providing step is preferably continuous. In addition, the method may also include providing additional workpieces with contact openings and repeating the aligning, severing, and transferring steps in a continuous manner to provide multiple electrical contacts on one or more workpieces.

The system for providing an electrical contact on a workpiece preferably includes an elongated member for forming a contact insert, a workpiece in association with the elongated member and having a contact opening, and a cutoff press for cutting off a portion of the elongated member to form the contact insert and for seating the contact insert in the contact opening defined in the workpiece. The elongated member is passed through a progressive die mounted in a punch press, with the cutoff press also mounted in the punch press.

The system may also include a pressure pad for holding the workpiece in position during seating of the contact insert in the contact opening in the workpiece. The cutoff punch and pressure pad are part of a punch press. The system may include a staking punch retained in a punch retainer for deforming an end of the contact insert after the insert is inserted into the workpiece to secure the contact insert to the workpiece to define the electrical contact. The system may also include a feed system for continuously feeding the elongated member into the punch press and the punch press may include a hole for guiding the contact insert into the contact opening. The punch press preferably includes a punch retainer for retaining the cutoff punch and the pressure pad. In one embodiment of the system, the elongated tape and cutoff punch are positioned over the workpiece and the staking punch is positioned under the workpiece.

The electrical contact system of the present invention advantageously includes a contact insert and a workpiece. The contact insert has at least two substantially planar side walls that define the width or length of the electrical contact and the workpiece has an opening configured and dimensioned for receiving at least a portion of the contact insert. The contact insert is preferably configured and dimensioned for receiving at least a portion of the contact insert. The contact insert is secured to the workpiece to define the electrical contact thereon.

The contact insert may have a body portion, at least four side walls, and is preferably formed by severing a first portion of an elongated member to form the at least two substantially planar side walls. The body portion of the insert may be rectangular and deformable. The opening in the workpiece is configured and dimensioned for matingly receiving at least a portion of the body portion of the contact insert. The contact insert may also include a head portion and at least one shoulder defined between the body portion and the head portion for abutting against a surface of the workpiece. The head portion may also be rectangular.

The electrical contact forming member of the present invention preferably includes an elongated tape having a head portion connected to a base portion, with the tape being severable along the length of the tape to form at least one contact insert for insertion into an opening defined in a workpiece to provide an electrical contact thereon. The head portion is preferably wider or longer than the base portion. The base portion may be welded to the head portion and the head portion may include an inlay on an exterior surface thereof. The head portion may include a recess with the inlay provided in the recess. The inlay may be axially aligned along the exterior surface of the head portion. The head portion and body portion may be of the same material or of different materials. The materials may preferably be silver, copper, gold, palladium, platinum, or alloys thereof. The base and head portions may both be deformable.

### BRIEF DESCRIPTION OF THE DRAWINGS

Preferred features of the present invention are disclosed in the accompanying drawings, wherein similar references characters denote similar elements throughout the several views, and wherein:

FIG. 1 is a perspective view of an elongated tape of the present invention;

FIG. 2 is a cross-sectional view of a contact insert made from the tape of FIG. 1 and secured to a metal stamping;

FIG. 3 is a perspective view of a rectangular contact insert formed from the tape of FIG. 1, deformed and with the metal stamping removed to show the finished contact element;

FIG. 4 is a perspective view of the tape of FIG. 1 showing an outline of round contact inserts severable from the tape;

FIG. 5 is a perspective view of the round contact insert of FIG. 4, deformed and with the metal stamping removed to show the finished contact element;

FIG. 6 is an end view of another elongated tape of the present invention showing the tape made from two distinct materials;

FIG. 7 is a perspective view of another elongated tape of the present invention in which the tape is formed from two types of materials;

FIG. 8 is a perspective view of a rectangular contact insert formed from the tape of FIG. 7, deformed and with the metal stamping removed to show the finished contact element;

FIG. 9 is a perspective view of another elongated tape of the present invention showing an inlay in the head portion of the tape;

FIG. 10 is a perspective view of a rectangular contact insert formed from the tape of FIG. 9, deformed and with the metal stamping removed to show the finished contact element;

FIG. 11 is a perspective view of the tape of FIG. 9 showing an outline of round contact inserts severable from the tape;

FIG. 12 is a perspective view of the round contact insert of FIG. 11, deformed and with the metal stamping removed to form a finished contact element;

FIG. 13 is a perspective view of another elongated tape of the present invention after the rectangular contact insert has been severed from the tape;

FIG. 14 is a perspective view of the rectangular contact insert formed from the tape of FIG. 13, deformed and with the metal stamping removed to show the finished contact element;

FIG. 15 is a perspective view of the tape of FIG. 13 after round contact inserts have been severed from the tape;

FIG. 16 is a perspective view of the round contact insert formed from the tape of FIG. 15, deformed and with the metal stamping removed to show the finished contact element;

FIG. 17 is a diagrammatic view of one embodiment of the system for forming an electrical contact on a workpiece, with the system in an open position;

FIG. 18 is a diagrammatic view of part of the system of FIG. 17 showing the system in an intermediate position with the cutoff punch in contact with the elongated tape;

FIG. 19 is a diagrammatic view of part of the system of FIG. 17 showing the system in an intermediate position after the contact insert has been severed from the tape but prior to staking the contact to the workpiece;

FIG. 20 is a diagrammatic view of the system of FIG. 17 showing the system in a closed position after the contact insert has been staked to the workpiece, but prior to ejection of the workpiece from the system;

FIG. 21 is a diagrammatic view of another embodiment of the system for forming an electrical contact on a workpiece with the system in an open position, prior to severing the elongated member; and

FIG. 22 is a diagrammatic view of the system of FIG. 21 showing the system in a closed position after the contact insert has been severed from the elongated member and staked to the workpiece, but prior to ejection of the workpiece from the system.

### DETAILED DESCRIPTION OF THE INVENTION

Although the present invention can be made in many different forms, the preferred embodiments are described in this disclosure and shown in the attached drawings. This disclosure exemplifies the principles of the present invention and does not limit the broad aspects of the invention only to the illustrated embodiments.

The present invention is directed to a contact insertion tape for use in a contact insertion system. This tape, which is also referred to herein generally as an elongated member, has a shape which allows for inserting pieces into a workpiece after the pieces have been severed from a continuous length of a metal product, such as a clad metal tape. The tape may preferably be continuously clad or bonded metal including of at least one layer of contact alloy, referred to herein as a contact layer, metallurgically bonded to a carrier substrate, referred to herein as a carrier layer.

The contact layer is a functional layer which forms the contact surface for making and breaking a circuit in an electrical device. This layer is typically made of silver, silver alloys, gold, gold alloys, palladium, palladium alloys, platinum, platinum alloys, copper, and copper alloys, among others. The contact alloy layer provides the wear surface of the contact element and is selected according to the operating environment, taking into account such criteria as voltage requirements, amperage requirements, and other electrical design criteria. The contact alloy layer will vary in thickness and material according to the individual designed life criteria.

The carrier layer is also a functional layer which facilitates the association of the contact layer to the workpiece. The carrier layer is often the body portion of a contact insert and allows the user to coin, swage, or deform the individual contact insert into place when inserted into a hole in the workpiece. In order to deform the contact insert, the material of the carrier layer must be of sufficient ductility to allow for deformation of the insert to establish the connection between the contact insert and the workpiece. The carrier layer also provides conduction of electricity between the contact insert and the workpiece and provides thermal conductivity which allows for dissipation of heat from the contact layer by dispersing the heat along the workpiece. Contact layer materials may be used for the carrier layer. Contact layer materials may be particularly useful where the upset portion of the shank or body of the contact insert is to be used as a contact point on a double acting arm.

Contact insertion tape is preferably manufactured under controlled conditions of cleanliness. Properly prepared materials are clad together in a manner using heat and pressure in a continuous manner to create an intimate metallurgical bond between the layers of material. The tape, and more preferably the head portion of the insertion tape, may be formed into a designed shape, such as flat, radiused, conical, winged, domed, triangular, or other shapes. The metallurgical bond is important for proper electrical conductivity, reduced heat generation caused by interface resistance, and improved thermal conductivity.

The tape is preferably non-destructively tested in a cost effective manner to ensure the product's integrity. The tape is preferably of proper shape, width, and other electrical characteristics, to replace existing rivet-type electrical contacts. A contact insert having an appropriate shape and width ratio of contact surface material to body material is desirable.

Continuously bonded tape products which have been used for creating contact elements on workpieces have previously been known to utilize a base carrier with a width which is equal to or greater than the contact surface layer (when viewed in cross-section). The present invention utilizes contact insertion tape technology without the need to weld the contact layer to the workpiece. Instead, the contact insertion tape may utilize a cross-section which is T-shaped, or any other shape, such as rectangular or L-shaped, for instance, for insertion into a hole defined in a workpiece. The present invention eliminates the need to weld the insert to the workpiece and provides for a cost-effective, efficient, and highly automated method for inserting a contact insert into a workpiece. Conventional rivet-type contacts cannot be utilized in welding applications and currently known welding tapes cannot be used in rivet applications. The present invention improves upon technology from both applications to create a concept which incorporates ease of handling and economic advantages over both previously known applications.

Furthermore, prior rivet-type contacts were required to be made from a ductile material because they are formed by a cold-heading operation, which requires deforming a wire to create a head portion. Because the present invention does not utilize cold-heading to create the contact insert, the contact insert may be made from harder materials, which will reduce the wear on the contact element and provides for greater flexibility in material selection.

While it is possible to utilize multiple materials on the head of a conventional rivet-type contact made by a cold-heading operation, conventional parts are limited in that the thickness of the cold-headed layers must meet certain design criteria in order to be effectively applied. Also, with prior rivet-type contacts, it is difficult to selectively electroplate the rivets. Instead, the entire body of the rivets is typically electroplated, including the shank portion which seats in an opening in a workpiece. This wastes materials, such as gold. In contrast, since the present invention utilizes an elongated tape, the tape can be selectively electroplated. For instance, the head portion of the tape may be electroplated or coated with a fusable metal, or the shank or body portion of the tape may be electroplated or coated with a fusable metal. Alternatively, portions of the head portion or body portion may be coated with a layer of material. The present invention provides for greater flexibility and a broader range of thicknesses for materials which may be coated on the tape. For instance, layers as thin as approximately 50/1,000,000 of an inch may be effectively applied to a portion of the elongated tape, which is not possible with conventional rivet-type contacts.

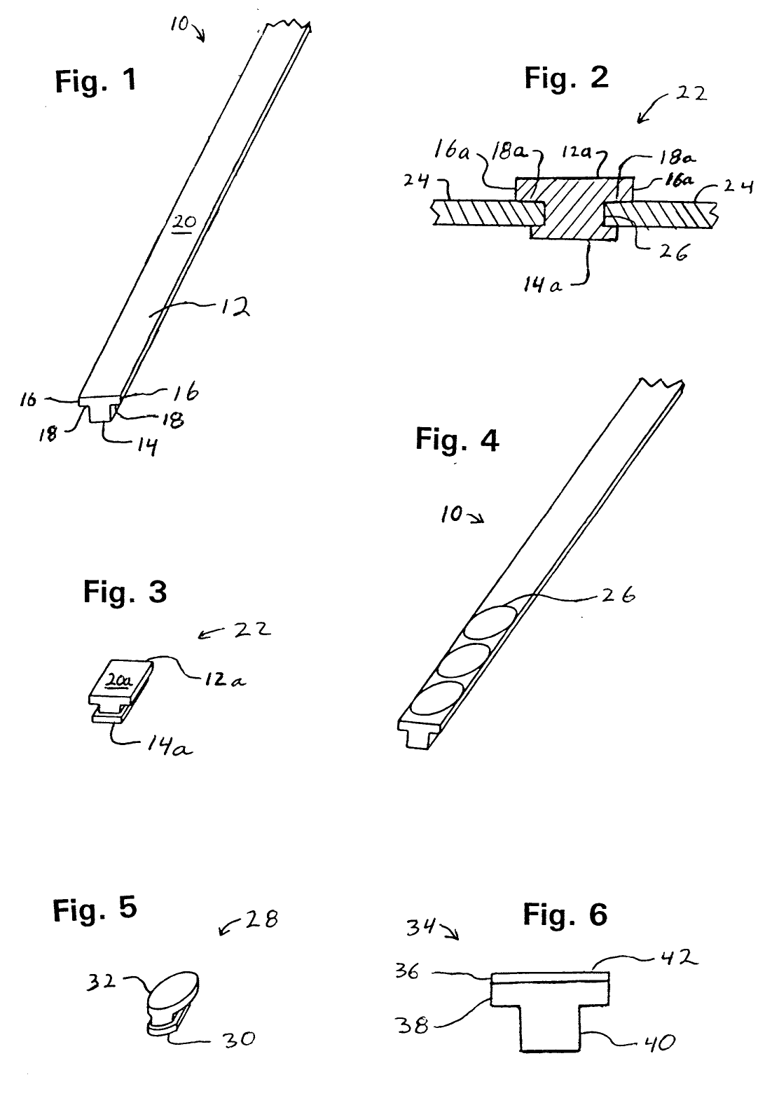

Referring to the figures, an elongated member 10, such as a metal tape or wire made according to the present invention, is shown in FIG. 1. The tape 10 has an elongated head portion 12 and an elongated body portion 14 extending from the head portion 12. Preferably, the body portion 14 extends from the head portion 12 substantially along a centerline of the head portion 12, although other shapes are also contemplated, such as ones wherein the body portion 14 is not substantially aligned along the centerline of the head portion 12. Two opposed wings 16 preferably extend laterally outward from the head portion 12 and away from the body portion 14. Two shoulders 18 are preferably formed at the junction of the head portion 12 and the body portion 14. The head portion 12 has a greater width than the body 14 and the difference in widths forms the shoulders 18. The tape 10 is preferably T-shaped in cross-section because of the widths of the head portion 12 and body portion 14, and because of the wings 16 and the shoulders 18. However, the tape 10 could have other desired cross-sectional shapes depending on the shapes and sizes of the head portion 12 and the body portion 14 and the location that the body portion 14 is connected to the head portion 12. For instance, it is also contemplated that the elongated tape 10 may have only one or no shoulders 18 and that the head portion 12 may be domed, triangular, radiused, or any other types of desirable shape.

The elongated member 10 can be severed at desired spaced apart locations along the length of the member to form contact inserts 22 which can be utilized like conventional rivet-type electrical contacts. Rectangularly shaped contact inserts are formed by severing the tape 10 transversely relative to the longitudinal length of the elongated tape 10. The tape 10 may be formed from a single type of material, such as silver. Other materials suitable for electrical contacts can also be used, such as, for example, copper, gold, palladium, and alloys of these materials. When the tape 10 is severed into a contact insert 22, the head portion 12 and the body portion 14 become a head and body of the contact, respectively. The contact insert, as shown, typically includes four sides, two of which are substantially planar due to the severing of the elongated tape 10 along a common plane. A head portion contact surface 20 forms the electrical contact surface on the contact insert.

A contact insert 22 made from the tape 10 and secured to a metal stamping or workpiece 24 is shown in FIG. 2. The stamping 24 has a hole 26 into which the contact insert 22 is inserted. A body 14a of the contact 22 is deformed during a staking operation to secure the contact insert 22 to the stamping 24. During the deformation process, the previously substantially planar side walls of the contact insert 22 will typically become non-planar. The stamping 24 is secured between a contact head 12a and the deformed body 14a, and its adjacent two wings 16a and shoulders 18a.

Referring to FIG. 3, the contact insert 22 is shown with the stamping 24 removed after the end of the body portion 14a has been staked, or deformed. In this embodiment, the tape 10 has been severed such that the contact insert 22 has the rectangularly shaped contact head 12a and contact surface 20a. The contact head 12a and contact surface 20a are not deformed when the contact insert 22 is staked to the stamping 24. In other words, the contact head 12a and the contact surface 20a retain their size and shape after the contact 22 is secured to the stamping 24 because the contact head 12a is not deformed.

Multiple contacts 22 are made by severing the tape 10 (FIG. 1) at spaced apart locations along the tape 10 such that each severing location defines opposing sides adjacent contacts. Waste material from the process of severing the tape 10 into contacts can be minimized by severing the tape such that the contacts are adjacent each other on the tape prior to the severing. The tape 10 can be severed into contact inserts having any desired head shapes. For example, FIGS. 4 and 5 show a round outline 26 of a round shaped contact 28. The round shaped contact 28 is shown in FIG. 5 after the end of the contact body 30 is deformed and the workpiece has been removed. The round shaped contact head 32 is not deformed by securing the contact 28 to the stamping.

An end view of another elongated tape 34 according to the present invention is shown in FIG. 6. This embodiment is similar to the tape 10 of FIG. 1, except a contact layer 36 is bonded to the head 38 forming a composite tape. The tape contact layer 36 is made from a different material than the rest of the head 38 and the body 40. For example, the contact layer 36 can be made from silver and the remaining portion of the tape 34 can be made from copper. The composite tape 34 produces contacts having the benefits of a silver contact surface 42 while reducing costs by making the rest of the contact from copper.

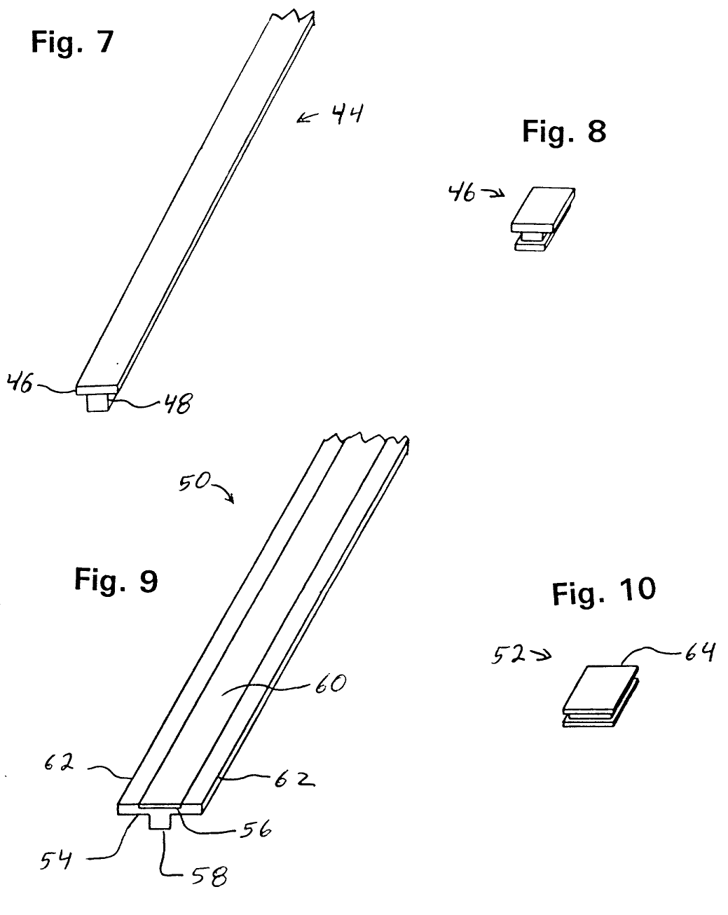

Another elongated tape 44 and contact insert 46 according to the present invention are shown in FIGS. 7 and 8. The tape 44 has a head portion 46 bonded to a body portion 48 which are made from different materials. For example, the head portion 46 can be silver and the body 48 copper, forming a composite tape. The body 48 can be bonded to the head portion 48 by any method acceptable for making electrical contacts, for example, edge welded or fused. The composite head portion 46 is shown in FIG. 8 as rectangular and with the stamping removed. However, the tape 44 can be severed into any desired contact shape.

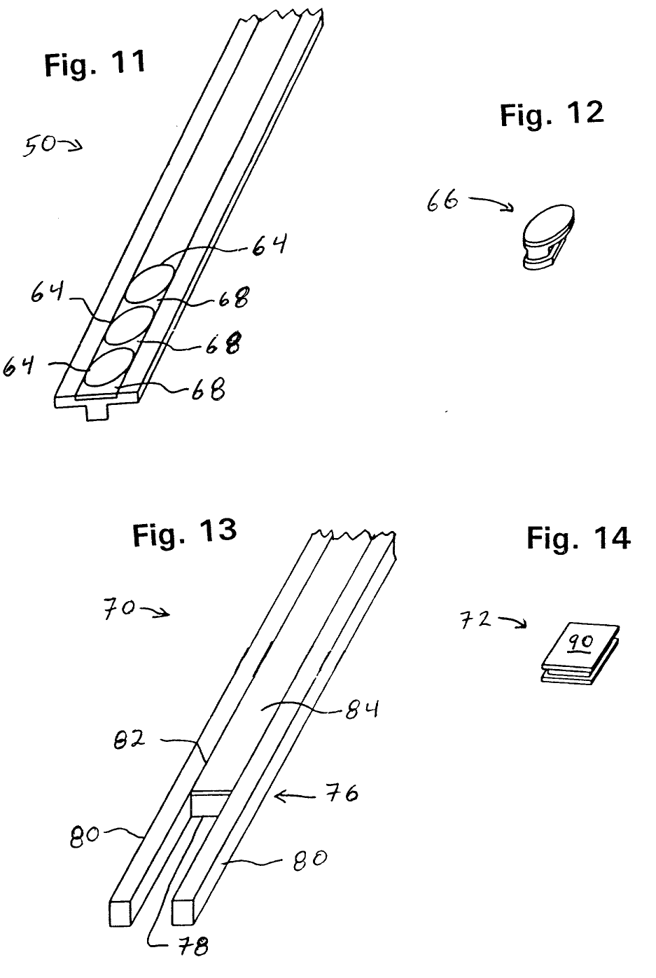

Another elongated tape 50 and contact insert 52 according to the present invention are shown in FIGS. 9 and 10. The tape 50 is a composite tape and has a head portion 54 defining an elongated recess 56 and a body portion 58 extending from the head portion 54. An elongated inlay 60 is bonded to the head 54 in the recess 56. The head portion 54 has opposing rails 62 on either side of the inlay 60. The materials of the inlay 60 and the remaining portion of the tape 50 are different from each other, such as a silver inlay 60, with the remaining portion of the tape being made of copper. The composite tape 50 can be severed into rectangular contact inserts 52, shown in FIG. 10. The tape 50 is severed such that the inlay 60 forms a contact head 64 and the rails 62 remain as part of the tape 50. In this manner, the head portion 54 with the rails 62 forms a carrier for the inlay 60. FIG. 11 shows the tape 50 of FIG. 9 with a round outline 64 of a round shaped contact 66. The round shaped contact 66 is shown in FIG. 12, after the end of the body portion has been deformed, with the stamping removed. Severing the round shaped contact 66 from the tape 50 may leave webs 68 in the tape 50 after the contacts 66 are blanked from the tape.

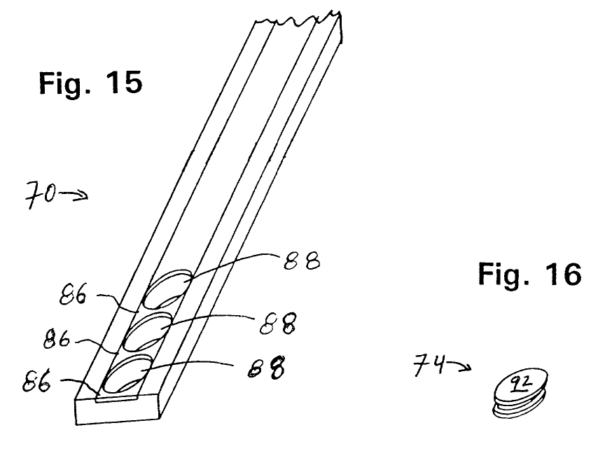

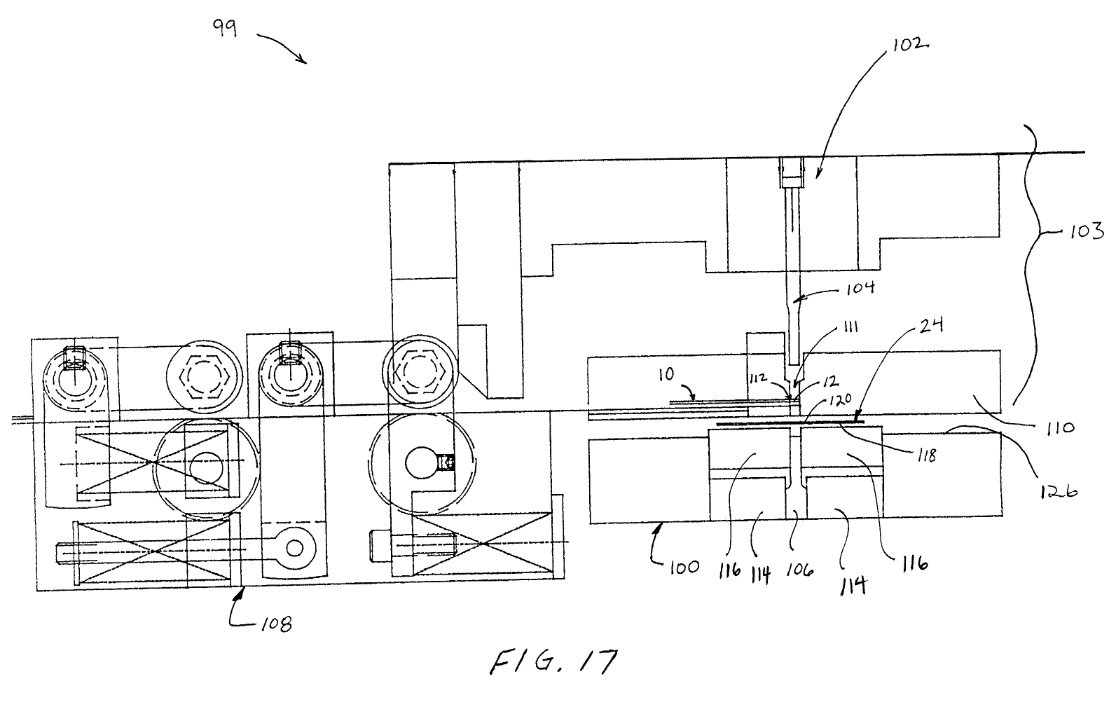

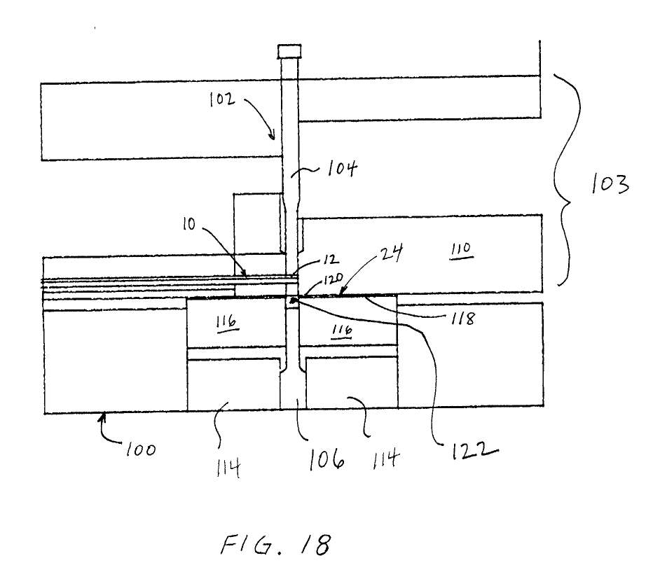

Another elongated tape 70 according to the present invention is shown in FIGS. 13 and 15. FIG. 13 shows the tape 70 after rectangularly shaped contacts 72 (FIG. 14) have been severed from the tape 70, and FIG. 15 shows the tape 70 after round shaped contacts 74 (FIG. 16) have been severed from the tape 70. The tape includes an elongated base having a mid-portion 78 and rails 80 on opposite sides of the mid-portion 78. An elongated recess 82 extends along the length of the base 76. An elongated inlay 84 is bonded to the base 76 in the recess 82. The inlay 84 and the base 76 are made from materials suitable for electrical contacts such as, for example, silver, copper, gold, platinum, palladium, and alloys of these metals. For example, the base 76 can be copper and the inlay 84 silver.

Various shapes of contacts can be made from the tape 70. For example, the rectangularly shaped contacts 72 can be severed from the tape 70 on three sides adjacent to each other (FIG. 13) such that the rails 80 remain connected to the tape 70. The locations on the tape 70 where the contacts are severed can be spaced further apart to leave webs 86 and holes 88 as shown in FIG. 15. As shown in FIGS. 14 and 16, the inlay 84 forms outer surfaces 90, 92 on the contacts 72, 74. The outer surfaces 90, 92 are brought into contact with other electrically conductive elements (not shown) to complete an electrical connection. The heads of the contacts 72, 74 can be deformed during the process of securing the contacts to a stamping. The elongated tape 70 is the carrier to deliver the silver inlay 84 to where it can be utilized as a contact. This variation does not necessarily require the T-shape, as shown in the figures. The contact insert, when it is severed from the tape, has at least two substantially planar side walls. When the contact insert is severed from tape 70, it is inserted into the stamping and is deformed or headed on both sides to retain itself to the stamping. This variation can be less costly than the T-shaped wire and is suitable for certain applications. Alternatively, a portion of the base 76 may be removed to form shoulders on the contacts 72, 74, similar to the shoulders on the contacts in the previous embodiments.

The elongated members or tapes of the present invention are used to make multiple contact inserts, which may be utilized in a manner similar to conventional rivet-type contacts. The tape is continuously fed into a cutter and the tape severed into multiple contact inserts. The contact inserts may be placed in a hole in a stamping and the body of the contact insert may be deformed to secure the contact insert to the stamping. The head of the contact insert is, preferably, not deformed. However, it is anticipated that their will be situations where it is desirable to deform both the base and the head. Thus, this feature is also contemplated by the present invention.

The operation of system 99 is summarized below. The tape 10 can be fed directly into a progressive die 100 used to make the stamping 24. The tape 10 is severed, inserted into the stamping 24, deformed and secured to the stamping 24 all within the die 100 and, most preferably, without deforming the head 12 of the contact insert 22. At least two embodiments for assembly are described herein, including one in which the elongated member 10 is fed from below the workpiece 24 and one in which the elongated member 10 is fed from above the workpiece 24.

Referring to FIGS. 17-20, a preferred system 99 for assembling an electrical contact on a workpiece 24 utilizes a progressive die 100 mounted in a punch press 103 having a punch retainer 102 and a cutoff punch 104, a staking punch 106 in conjunction with a second punch retainer 114, and a feed system 108. In a first embodiment, the die 100 includes a pressure pad or sublined stripper 110 positioned over a vertical hole 111 in the pressure pad or stripper 110. A sublined stripper has guide pins which help to maintain the stripper in alignment with the pressure pads 116, below. The hole 111 in the pressure pad or sublined stripper 110 provides sufficient clearance to accept the elongated tape 10 for processing. The hole 111 in the pressure pad or stripper 110 may be rectangular, square, or any other suitable shape.

As shown in FIG. 17, die 100 is in the open position wherein the feed system 108 can readily feed the elongated tape 10 through opening 112 defined in the pressure pad or stripper 110. The cutoff punch 104 is in position above the vertical hole 111 defined in the pressure pads and is ready to move downward to sever tape 10.

Referring now to FIG. 18, the progressive die 100 is shown in an intermediate position before the cutoff punch has severed the contact insert 22 from the tape 10. In this position, workpiece 24 is clamped between pressure pad 110 and pressure pad 116. After the elongated tape 10 is severed by cutoff punch 104, as shown in FIG. 19, contact insert 22 is moved downwardly in opening 111 and is ready to be inserted and staked into the workpiece 24. Staking generally involves deforming a portion of the contact insert 22 to conform to the workpiece 24 and is used to secure the electrical contact to the workpiece 24. Use of a staking operation, in conjunction with inserting the contact insert 22 into a hole 122 defined in the workpiece 24, avoids the need to weld the contact to the surface of the workpiece 24.

A staking punch 106 is preferably retained by a second punch retainer 114 in the die block 100. Another pressure pad or spring pad 116 applies pressure to the bottom side 118 of the workpiece 24 so that the cutoff punch 104 can contact the head portion 12 of the contact insert 22 to force the head portion 12 to abut the workpiece 24. The head portion 12 of the contact insert 22 preferably rests against an outer surface 120 of the workpiece 24 during staking.

As shown in FIG. 19, after the cutoff punch 104 has severed the contact insert 22 from the tape 10, the contact insert 22 moves downwardly and enters the hole 122 defined in the workpiece 24. In this intermediate position, the head portion 12 of the contact insert 22 rests against the outer surface 120 of the workpiece 24 and the body portion 14 is seated within opening 122.

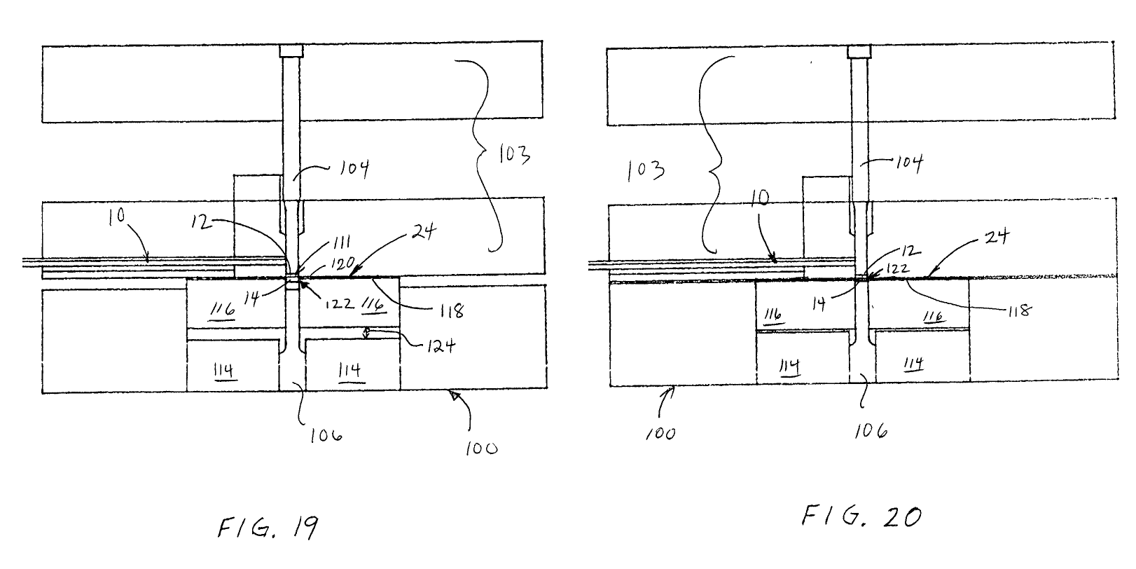

Referring to FIG. 20, in order to stake the body portion 14 to the workpiece 24, the punch press 103 presses the workpiece downwardly against the pressure pads 116 and compresses the pressure pads 116 to close the gap 124 between the staking punch 106 and the base portion 14 of the contact insert 22. As the punch press 103 moves downwardly, the staking punch 106 deforms the lowermost end of the body portion 14 of the contact insert 22 to secure the contact insert 22 to the workpiece 24 to form a contact element.

The system 99 also preferably includes a feed system or insertion module 108 for feeding the elongated tape 10 into the die block 100, as shown in FIG. 17. A customized, dedicated feed is preferred. However, commercially available feeds are also available to feed the elongated tape 10 into the die 100. For instance, commercially available feeds may be mechanical or pneumatic. Commercially available feeds may be powered by a cam driven by the punch press or actuated by an electrical impulse provided by a rotary cam on the crankshaft of the punch press. The type of feed utilized, however, is not essential to the invention.

The elongated tape 10, preferably in the form of a T-shaped tape, enters the die 100 through the insertion module 108, which is preferably installed in the punch press. The workpiece 24 can enter the punch press 103 from the left or right side and travels through the die 100. The die 100 has an open and closed position. When the die 100 is in an open position, sufficient clearance is provided between the top surface 126 of the die block 100 and the sublined stripper or pressure pad 110 to permit the workpiece 24 to enter and exit the die 100. When the die 100 is open, the pressure pad 110 is preferably in the open position.

After the contact insert 22 has been staked to the workpiece 24, as shown in FIG. 20, the press then opens and the cutoff punch 104 and stripper 110 return to their neutral positions. The elongated tape 10 advances in the feeding apparatus 108. The completed assembly exits the press and a new workpiece 24 enters the press in order to repeat the process of contact insert insertion.

The elongated tape may enter the die 100 from the front, the rear, or both the front and rear of the die 100. Another aspect of the invention involves multiple insertions of contact inserts into a single or multiple work pieces simultaneously.

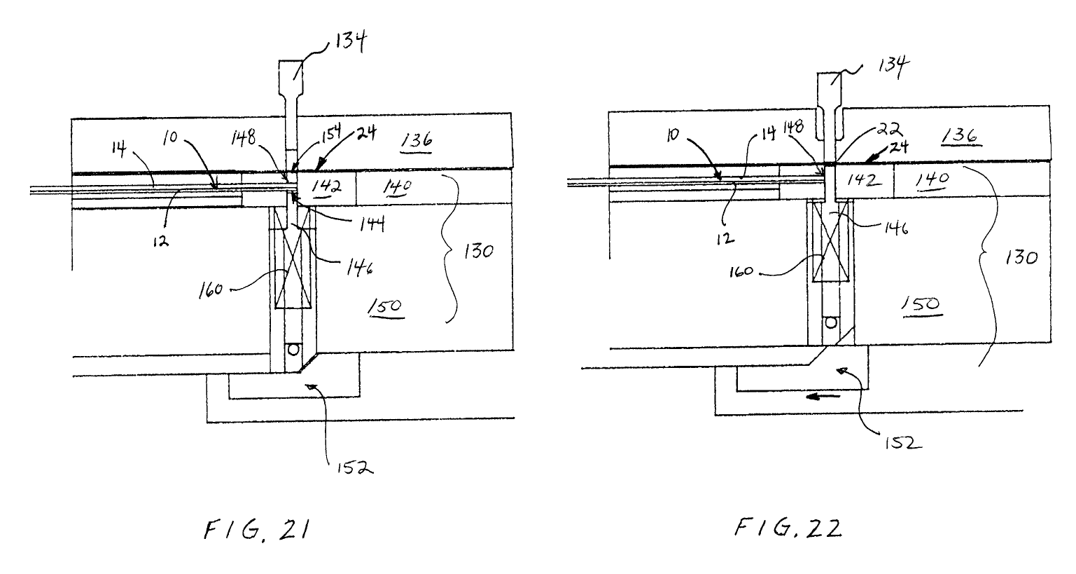

The above-described method involves top loading a workpiece 24 with a contact insert 22. Alternatively, another method of the present invention involves loading the workpiece 24 with a contact insert 22 from beneath the workpiece 24, as depicted in FIGS. 21 and 22. In this alternative embodiment, the punch press module 130 consists of a punch retainer (not shown) with a staking punch 134 and a stripper 136. The stripper 136 preferably includes a vertical hole for admitting the staking punch 134 therethrough. The punch press module 130 also preferably includes a die holder 140 which retains a die insert 142. The die insert 142 preferably includes a vertical hole 144 for admitting the cutoff punch 146 and staking punch 134. Both holes include a horizontal contoured hole 148 which allows the elongated tape 10 to access the vertical hole 144 in the die insert 142. A base 150 preferably retains the die holder 140. The vertical hole 144 of the die insert 142 retains and locates the cutoff punch 146. A cutoff punch 146 assembly can be advanced upward and be returned to its original, at rest position. A cam assembly 152 is preferably utilized to convert the downward motion of the press 130 into an upward motion of the cutoff punch assembly 146, which is biased by spring 160. The elongated tape 10 is preferably inserted into the die insert 142 through an insertion module (not shown). The insertion module is preferably installed in the punch press 130. The elongated tape 10 can enter the die insert 142 from any number of locations, such as the left side, right side, front, rear or any combination of these positions.

In operation, as the press is opened, the assembled workpiece 24 progresses out of the punch press module 130 to allow another workpiece 24 to enter the die for assembly. When the press is opened, it is at rest. As the press is opened, the elongated tape 10 advances into position in the vertical hole 144 in the die insert 142, as shown in FIG. 21. In this position, the elongated tape 10 may be cut off and staked. The elongated tape 10 is preferably positioned beneath a hole 154 defined in the workpiece 24. As the press descends or closes, as depicted in FIG. 22, the stripper 136 preferably clamps down the workpiece 24 to face the die insert 142. The cam assembly 152 raises the cutoff punch 146. As the cutoff punch 146 is raised, the next contact insert 22 is severed from the elongated tape 10. The cutoff punch 146 then raises the contact insert 22 up through the vertical hole 144 in the die insert 142 until the contact insert 22 mates with the workpiece 24. When pressure is established between the cutoff punch 146 and the workpiece 24, the cutoff punch 146 ceases advancing. The staking punch 134 then impacts the vertical body portion 14 of the contact insert 22 to securely stake the insert 22 to the workpiece 24, thereby defining the contact element on the workpiece 24. In the staking process, the staking punch 134 moves downwardly from above the workpiece 24.

A load sensor (not shown) may preferably be installed in the press beneath the staking punch to monitor the force generated by the staking punch. If variations occur relative to preset values, the press will cease operation pending evaluation by the operator. Alternatively, the press may remove any defective parts into a scrap bin.

A coining station (not shown) may also be provided to modify the exposed surfaces of the contact insert 22. For instance, a spherical, conical, domed, triangular, or other surface shape may be desired. Coining may occur either before or after the contact insert 22 is inserted into the hole in the workpiece 24. Alternatively, the elongated tape 10 may be pre-contoured to a desired shape.

As is evident, the contact inserts 22 of the present invention are superior to previously known rivet-type contacts because the contact elements of the present invention provide a greater surface area of contact, due to the rectangular shape of the hole and insert. Provided that the elongated tape 10, contact insert 22, and hole in the workpiece 24 are properly proportioned, the contact insert 22 may intimately contact all four sides of the hole in the workpiece 24. This is even more true after the insert 22 has been staked in the hole, because staking causes the insert to deform and can advantageously result in making the body of the insert contact all four walls of a rectangular hole defined in a workpiece 24. For example, a prior art 0.12 inch diameter contact with a 0.06 inch shaft which is staked into a 0.03 inch hole in a workpiece 24 has a surface area of contact of 0.00565 square inches. The contact element of the present invention, in contrast, having a body which is 0.06 inches by 0.110 inches, provides a surface area of contact of 0.0102 square inches.

In addition, the present invention provides for greater flexibility in selecting a size for the electrical contact. Since workpieces are typically elongated and somewhat narrow, an increase in the size of a conventional (round) rivet-type contact can often-times make the contact too large for the workpiece. The present invention, in contrast, can be readily enlarged longitudinally by increasing the length of the contact insert. Since the present invention is directed toward a rectangular insert, the inserts of the present invention will typically fit better on elongated and narrow workpieces, thus providing greater flexibility than conventional rivet-type contacts.

The present invention reduces operating costs because the present system reliably feeds a tape instead of inserting small, lightweight rivet-type contacts into position in the assembly. Furthermore, the use of a rectangular contact insert allows for the use of heads of sufficient volume to better dissipate heat and also eliminates the need for performance testing, which is normally required in connection with contact welding tape (punch test) or for conventional rivet-type contacts (rotation or torque testing).

It should be understood that variations and modifications within the spirit and scope of the invention may occur to those skilled in the art to which the invention pertains. Accordingly, all expedient modifications readily attainable by one versed in the art from the disclosure set forth herein that are within the scope and spirit of the present invention are to be included as further embodiments of the present invention. The scope of the present invention accordingly is to be defined as set forth in the appended claims.

What is claimed is:

1. A method of providing an electrical contact on a workpiece, said method comprising:
providing a workpiece with a contact opening;
aligning an elongated member with the contact opening of the workpiece;
severing a portion from said elongated member to define a contact insert; and
transferring said contact insert to the contact opening of the workpiece for securement thereto to provide an electrical contact on the workpiece.

2. The method of claim 1, wherein at least part of said contact insert is deformable and which further comprises securing the contact insert to the workpiece by deformation against the workpiece.

3. The method of claim 1, which further comprises exerting a force to cause said severing and transferring steps to occur in concert.

4. The method of claim 1, wherein said providing step occurs while the workpiece and contact insert are aligned within the die.

5. The method of claim 1, which further comprises configuring the elongated member as a metal tape having a head portion, a body portion associated with said head portion, and at least one shoulder defined between said head portion and said body portion so that said contact insert includes said head portion, body portion, and shoulder portion after said elongated member is severed.

6. The method of claim 5, which further comprises providing said body portion of deformable material to facilitate securing of the contact insert to the workpiece.

7. The method of claim 5, wherein said transferring step further comprises inserting only the body portion of the contact insert into the contact opening defined in the workpiece.

8. The method of claim 7, wherein said positioning step further comprises abutting said head portion of said contact insert against the workpiece to position the contact insert in the contact opening.

9. The method of claim 1, wherein said providing step is continuous.

10. The method of claim 1, which further comprises configuring said elongated member to have a substantially T-shaped transverse cross-section.

11. The method of claim 1, which further comprises providing additional workpieces with contact openings and repeating the aligning, severing, and transferring steps in a continuous manner to provide multiple electrical contacts on one or more workpieces.

12. A system for providing an electrical contact on a workpiece, said system comprising:
an elongated member for forming a contact insert;
a workpiece in association with said elongated member and having a contact opening; and
a cutoff press for cutting off a portion of the elongated member to form the contact insert and for seating the contact insert in the contact opening defined in the workpiece.

13. The system of claim 12, which further comprises a pressure pad for holding the workpiece in position during seating of the contact insert in the contact opening in the workpiece and the cutoff punch and pressure pad are part of a punch press.

14. The system of claim 13, which further comprises a staking punch retained in a second punch retainer for deforming an end of the contact insert after the insert is inserted into the workpiece to secure the contact insert to the workpiece to define the electrical contact.

15. The system of claim 13, wherein the system further comprises a feed system for continuously feeding the elongated member into the punch press and the punch press includes a hole for guiding the contact insert into the contact opening.

16. The system of claim 13, wherein the punch press includes a punch retainer for retaining the cutoff punch and the pressure pad.

17. The system of claim 14, wherein the elongated tape and cutoff punch are positioned over the workpiece and the staking punch is positioned under the workpiece.

18. An electrical contact system comprising:
a contact insert having at least two substantially planar side walls that define the width or length of the electrical contact; and
a workpiece having an opening configured and dimensioned for receiving at least a portion of the contact insert;
wherein said contact insert is secured to the workpiece to define the electrical contact thereon.

19. The electrical contact system of claim 18, wherein said contact insert has a body portion, at least four side walls, and is formed by severing a first portion of an elongated member to form the at least two substantially planar side walls.

20. The electrical contact system of claim 19, wherein said body portion is rectangular.

21. The electrical contact system of claim 19, wherein the opening in the workpiece is configured and dimensioned for matingly receiving at least a portion of the body portion of the contact insert.

22. The electrical contact system of claim 19, wherein said contact insert further comprises a head portion and at least one shoulder defined between said body portion and the head portion for abutting against a surface of the workpiece.

23. The electrical contact system of claim 22, wherein said head portion is rectangular and said body portion is rectangular.

24. The electrical contact system of claim 18, wherein said contact insert has a body portion at least part of which is deformable to secure the contact insert to the opening.

25. An electrical contact forming member comprising an elongated tape having a head portion connected to a deformable base portion, wherein said elongated tape is severable along the length of the tape to form at least one contact insert for insertion into an opening defined in a workpiece to provide an electrical contact thereon.

26. The electrical contact forming member of claim 25, wherein the head portion is wider or longer than said base portion.

27. The electrical contact forming member of claim 25, wherein said base portion is welded to said head portion.

28. The electrical contact forming member of claim 25, wherein said head portion further includes an inlay provided on an exterior surface of the head portion.

29. The electrical contact forming member of claim 28, wherein said head portion further comprises a recess defined longitudinally along the exterior surface thereof and said inlay is provided in said recess.

30. The electrical contact forming member of claim 28, wherein said inlay is axially aligned along the exterior surface of the head portion.

31. The electrical contact forming member of claim 25, wherein said head portion and body portion are made of a first material.

32. The electrical contact forming member of claim 31, wherein the first material is silver, copper, gold, palladium, platinum, or alloys thereof.

33. The electrical contact forming member of claim 25, wherein said head portion is deformable.

34. The electrical contact forming member of claim 25, wherein said head portion is made of a material that is different from that of the base portion.
